(19) United States
(12) Patent Application Publication
(10) Pub. No.: US 2004/0025903 A1
(43) Pub. Date: Feb. 12, 2004

(54) Method of in-situ chamber cleaning

(76) Inventor: Bradley J. Howard, Boise, ID (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/217,251

(22) Filed: Aug. 9, 2002

(51) Int. Cl. B08B 6/00; C25F 1/00; C25F 3/30; C25F 5/00

(52) U.S. Cl. 134/1.1; 438/905

(57) ABSTRACT

An in-situ chamber cleaning method and apparatus used to remove adherent polymer deposits from the walls of a diode process reactor or chamber. Using this method, a high-density plasma is introduced into the reactor core and creates a reactive cleansing plasma by subsequent RF or capacitive discharge within the chamber. The cleansing plasma decomposes the polymer material into components, which may be readily removed from the chamber improving cleansing efficiency.

### BACKGROUND OF THE INVENTION

1. Field of the Invention

The present invention relates to plasma process reactors and, more particularly, to a method for cleaning RF diode plasma reactors.

2. Description of the Related Art

Chemical vapor deposition (CVD) techniques have been described for the formation of non-volatile solid films on various substrates, such as those used in semiconductor devices. CVD uses a vapor phase mixture of components which are introduced into a process chamber and desirably react on the substrate surface to form a thin film or coating. CVD processes may be further classified to include atmospheric pressure chemical vapor deposition (APCVD), low pressure chemical vapor deposition (LPCVD), and plasma enhanced chemical vapor deposition (PECVD).

Of the above-mentioned CVD methods, the PECVD technique, has become widely accepted in the semiconductor industry as an efficient method to initiate and sustain the chemical reactions necessary to create a substrate-deposited film. This technique uses a radio frequency (RF) induced glow discharge to transfer energy to the reactant gases creating a highly reactive plasma. The plasma comprises a partially ionized form of the reactant gases which efficiently react with the substrate to produce the film or deposit.

Another technique used in CVD and etch processes for generating plasma relies on capacitive coupling. In this technique, a capacitive electrostatic charge creates strong electric fields about an electrode and induces the formation of a plasma sheath region. The plasma sheath region is characterized by low electron density near the surface of the electrode and results in the bombardment of the electrode surface with ions, neutral molecules, and neutral radicals from the plasma. This technique is typically used in etching processes wherein the ion bombardment attacks a designated portion of substrate material and removes it from the surface of the substrate.

One drawback encountered when using plasma deposition and plasma etching processes is the undesirable deposition or accumulation of material on the internal surfaces of the reaction vessel. In PECVD, for example, not only does the substrate receive a chemical coating, but also, the plasma reacts with other surfaces in the process chamber. The plasma reaction with the chamber surfaces results in the deposition of material on the walls of the reaction vessel. In a like manner, plasma etch techniques result in the deposition of the etched materials and products from a gas discharge on the interior surfaces of the reactor. The chemical coating found on the chamber walls following use of PECVD and plasma etching processes typically comprises undesirable polymer compositions and other deposits such as SiO₂. The polymer compositions are particularly adherent to the reactor walls and arise from chemicals present in the atmosphere of the process chamber which crosslink with the reactor walls, such as, CF₂, CH₂ and CHF. These polymer compositions are highly-stable in nature and will be retained in the process chamber during subsequent runs. If allowed to accumulate, these deposits provide a source of particulate and/or chemical contamination in subsequent runs of the reaction vessel and may reduce the yield of the substrate which is to be coated or etched.

The problem of non-specific deposition or contamination within the reaction vessel is compounded by the chemical stability of the polymer composition. As a result, polymer deposits on the process reactors walls are often difficult to remove. Methods of cleaning wall-adhering materials have been proposed and include manual disassembly of the reactor vessel followed by acid or solvent washing. Disassembly in this manner, although necessary in the absence of other cleaning methods, is undesirable for a number of reasons which include: increased reaction vessel downtime, required handling of highly corrosive or poisonous chemicals, and increased wear on the reaction vessel through repeated assembly and disassembly.

An improved method for cleaning process reactors is described in U.S. Pat. No. 5,647,913 and 5,980,688 both assigned to the assignee of the present application. These processes are based on an in-situ technique which does not require the disassembly of the reactor chamber and may be performed in an automated fashion. These processes describe methods to clean the process chamber by injecting a cleaning gas into the chamber and subsequently ionizing the cleaning gas into a reactive ionized species. While this cleaning technique is an improvement over other existing cleaning techniques such as acid or solvent washing, it remains inefficient and may not be suitable for all reactor types.

A problem arises when using the aforementioned in-situ cleansing techniques to remove polymer buildup within diode reactor chambers. Part of the problem stems from the inability of these methods to generate a sufficiently high density plasma within the chamber to efficiently attack and remove the polymer buildup. Conventional diode chambers are typically designed to operate with relatively low plasma densities, in the range of 1×10¹⁰-1×10¹¹ ions/cm³. This plasma density range is not sufficient to efficiently remove polymer buildup from the reactor walls. As a result, the cleaning times required to purge a process chamber or reaction vessel from the adhering species may be unduly long and result in unacceptable reactor downtime.

Other reactor chambers have been described which receive high density gas plasmas in excess of the above-mentioned range of ion densities. In these reactors, a high-density plasma source, exterior to the reactor, produces a plasma with sufficiently high ion and radical density so as to react with wall-adhering polymer buildup and aid in its removal. Although these reactors can perform in-situ cleansing of the reactor walls, they still suffer from ion and radical recombination during the cleansing process which contributes to reduced effective ion and radical densities. The spontaneous lowering of ion and radical densities due to recombination results in reduced cleansing efficiency and increased cleansing times.

In the absence of any other substantially improved process chamber cleaning methods, the prior art discloses only inefficient cleansing methods by which the material built up within the inside of a diode process chamber can be removed. A need therefore exists, for an improved cleaning method which effectively removes accumulated polymer buildup formed during operation of the diode process chamber. It is important for the cleaning technique to function as an in-situ operation to reduce the operational complexity of cleaning the reactor and minimize operator exposure to potentially harmful or dangerous substances. There is additionally a need for a cleaning technique which improves the thoroughness of the cleaning, while minimizing downtime experienced as a result of engaging in the cleansing process.

### SUMMARY OF THE INVENTION

The aforementioned needs are satisfied by the apparatus and method for in-situ cleaning and removal of polymer buildup of the present invention. In one aspect, a process reactor or chamber comprises an enclosure forming a reactor cavity and having internal walls which may become coated with a polymer material through successive use. The difficulty in removing the polymer material is mitigated by introducing an externally produced, high-density plasma into the reactor cavity to initiate the cleansing of the polymer material or coating. The cleaning action of the high-density plasma is further enhanced through the use of an electrode apparatus coupled to a capacitive power supply. An RF or electrical discharge is generated and transmitted into the reactor cavity to create a highly reactive cleansing plasma which readily reacts with the polymer material.

The process is further monitored by a control system which directs the cleaning of the chamber. The control system regulates the flow of high-density plasma into the chamber and maintains sufficient energy discharge into the plasma to increase the rate of removal of the polymer material.

In another aspect, a method for cleaning away polymer material from internal components of a process reactor comprises: (1) Introducing an externally produced, high-density plasma into the process chamber; (2) Subsequently striking a plasma-generating charge within the process chamber to increase the plasma potential of the high-density plasma; and (3) Maintaining conditions of ion bombardment within the process chamber by regulating both the high-density plasma flow into the chamber and the plasma generating charge to clean away the polymer material or coating.

Using the aforementioned apparatus and method, a high-density cleansing plasma is generated which efficiently reacts with adherent polymer material to produce an easily removed or volatile species. This method performs the required cleansing operations more quickly than existing methods due to the increased heat and energy sustained in the cleansing plasma which reacts more completely with the polymer material. Additionally, the cleansing plasma forms a highly dense atmosphere of particles which are inhibited from recombination and subsequent reductions in reactivity. The in-situ cleaning method can also be readily adapted to many different types and configurations of process reactors thus benefiting numerous industries and companies which are dependent on chemical vapor deposition or plasma etching techniques.

### BRIEF DESCRIPTION OF THE DRAWINGS

These and other objects and advantages will become more fully apparent from the following description taken in conjunction with the accompanying drawings which are meant to illustrate and not to limit the invention, and in which:

FIG. 1 illustrates a block diagram of the process chamber cleansing cycle.

FIG. 2 illustrates a cross-sectional view of an exemplary process chamber to be used in conjunction with the in-situ chamber cleaning method.

FIG. 3 illustrates a flowchart for the in-situ chamber cleaning method.

### DETAILED DESCRIPTION OF THE PREFERRED EMBODIMENT

Reference will now be made to the drawings, wherein like numerals refer to like parts throughout. The illustrated embodiments of the present invention describe a reactor design and cleansing method for in-situ cleansing of a diode driven process chamber. This design desirably uses a high-density plasma, introduced into the process reactor during a cleansing cycle. A plasma generating charge or plasma strike is further initiated in the reactor chamber to sustain the high-density plasma at levels which are effective for cleansing adherent polymer from the walls of the process chamber. The plasma strike also improves the cleansing action by accelerating the plasma ions towards the reactor walls with increased speed and momentum. As a result, polymer film or buildup can be more effectively removed from the diode reactor chamber in less time compared to that when using other conventional cleansing methods.

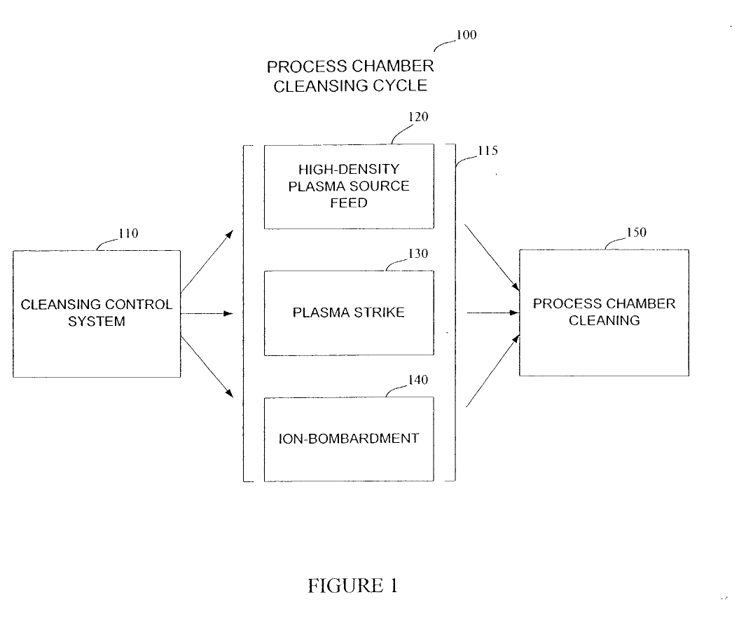

An overview of a method for in-situ cleansing of a process chamber or reactor is illustrated in FIG. 1. As mentioned in the “Background” section, polymer deposits form on the walls of diode reactor chambers during film depositing or etching steps. If left to accumulate, these polymer deposits contribute to potential substrate contamination and reduced product yield. In one aspect, the method of cleansing accumulated polymer deposits from the process chamber is directed by a cleansing control system 110 which is engaged during a process chamber cleansing cycle 100. The cleansing control system 100 coordinates and monitors stages 115 of the cleansing cycle 100, so as to maintain conditions for efficient cleansing of the process chamber. The stages 115 of the cleansing cycle 100 can be further broken down into a high-density plasma source feed stage 120, a plasma strike stage 130, and an ion-bombardment stage 140. These stages 120, 130, 140 serve to raise the ion density in the process chamber to a level which efficiently removes the polymer coating found on the interior walls of the process chamber.

Conventional diode reactors, although capable of generating relatively low-density plasmas, are not designed to produce the plasma density needed for efficient in-situ cleansing of the polymer material. The cleaning process of the illustrated embodiment, overcomes this limitation by using the high-density plasma source feed stage 120 in combination with the plasma strike stage 130 to produce an atmosphere which contains a substantially increased plasma density as compared to that of conventional diode reactors.

In one aspect, the plasma source feed stage 120 initiates the cleansing cycle 100 by introducing a dissociated gas stream into the atmosphere of the process reactor. The molecular composition of the gas stream desirably comprises a plurality of first particles wherein at least a portion of the gas stream is partially ionized, forming a plasma. The ionized species and radical species of the plasma react or combine with atoms in the polymer material or residue and transform portions of the solid material into a gas which is easily removed from the interior of the reactor during in-situ cleansing.

The dissociated gas stream or cleansing gas in one embodiment desirably comprises a mixture of SF₆, NF₃, CF₄, H₂, NH₃, and/or O₂ which are introduced into the chamber as a high-density plasma during the high-density plasma source feed stage 120. In the plasma, at least a portion of the cleansing gas is dissociated into highly reactive free radicals. One exemplary plasma species formation may result from the decomposition of diatomic oxygen into two free radical oxygen ions given by the equation:

O₂→O.+O.

The free radical oxygen subsequently reacts with carbon atoms in the polymer forming carbon monoxide or carbon dioxide and other volatile or gaseous species. These reactions provide a method to breakdown and remove the polymer or coating from the process reactor walls. Exemplary reactions illustrating the decomposition are given by:

0.+polymer→CO+other volatile or gaseous species

and

2O.+polymer→CO₂+other volatile or gaseous species

It will be appreciated by those of skill in the art that the aforementioned reactions serve only as exemplary reactions illustrating possible free radical formations and paths by which polymers react. Other free radical species may additionally be formed which likewise react with the adherent material. Hence, these embodiments desirably uses the free radical formation and reaction to convert the polymer material from a solid state to a volatile gaseous state, facilitating its removal from the interior of the process chamber.

In order to increase the rate of the aforementioned reactions involving the cleansing gas and the polymer, the plasma strike stage 130 follows the high-density plasma source feed stage 120. During this stage 130, the plasma density within the process reactor is maintained or increased using a RF or capacitive discharge. Furthermore, the capacitive discharge creates a highly energized plasma wherein the molecules and ions within the plasma move about more rapidly.

During the ion-bombardment stage 140, the plasma potential within the process chamber is maintained at an elevated level so as to direct a portion of the highly energized plasma against the side walls of the process chamber. During this stage 140, as ions are accelerated towards the process chamber interior walls and surfaces, they collide with the polymer material with sufficient enough energy to efficiently sustain the reactions necessary to result in the decomposition of the polymers.

An additional benefit resulting from the increased plasma potential is the inhibition of ion and radical recombination. Recombination in the plasma reduces the concentration of free radicals in the process chamber and leads to less effective cleansing. By maintaining a high plasma potential, the concentration of free radicals present in the cleansing gas is maintained or increased and therefore results in improved cleansing efficiency.

Process chamber cleaning 150 is thus driven by the aforementioned stages 115 which are used in cooperation and directed by the cleansing control system 110 in a manner that will be discussed in greater detail hereinbelow.

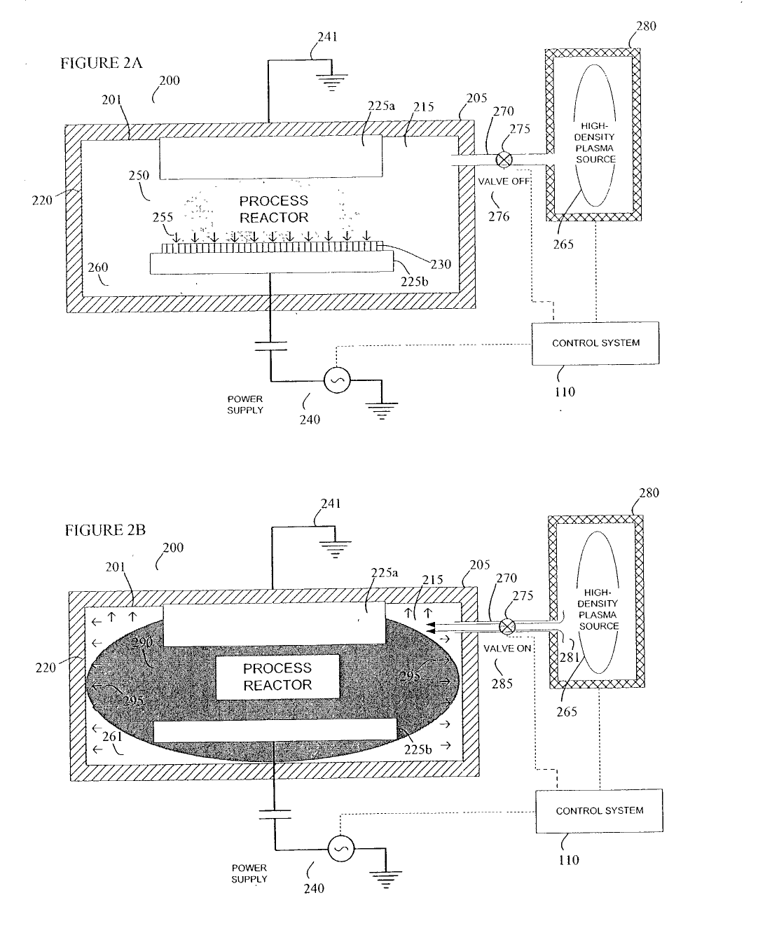

A process or reactor chamber 200 suitable for in-situ removal of accumulated polymers 201 is shown in FIGS. 2A and 2B. In one aspect, the chamber 200 comprises a shell 205 positioned so as to create a reactor core or enclosure 215 wherein materials and gases may be contained within interior walls 220 of the chamber 200. The composition of the shell 205 may further comprise numerous materials, as are known in the art of process chamber manufacture. For example, the chamber 200 may be constructed using materials, such as, for example; quartz, alumina, mullite, glass, polymer, ceramics, metals, composite materials, or any combination thereof.

In the illustrated embodiment, the chamber 200 functions as a diode process reactor wherein opposed electrodes 225a, 225b are positioned within the chamber 200. Substrates 230 are desirably film coated or etched by positioning within the chamber 200 in proximity to one of opposed electrodes 225a, 225b. A capacitive power apparatus 240 and suitable ground line 241 provide a source and path of energy used to generate plasma 250 by ionizing a portion of the coating or etching gas 260 within the chamber 200. Free “hot” electrons, formed as a result of a energy discharge, sustain the plasma 250 by striking other gas molecules resulting in increased ionization. Additionally, the energy discharge generates an electromagnetic field sheath about the electrode and substrate 230. The sheath acts to accelerate ionized gas particles 255 towards the electrode 225a, 225b and results in the desirable coating or etching of the substrate 230, dependent on the constituent gases 260 used during substrate processing.

As previously mentioned, over the course of one or more runs of the reactor 200, material 201 accumulates on the interior walls 220 of the reactor 200. Upon determination of the presence of sufficient deposited material 201 to require cleaning, the process chamber 201 is made ready for the cleansing cycle 100. This cleansing cycle 100 is desirably preceded by the removal of the substrate material 230 from the reactor 200 and the purging of the gaseous contents of the reactor interior 215.

The process or reactor chamber 200 of the present invention, additionally incorporates a feed line 270 which joins the process reactor 200 with a source of high-density plasma 265. Externally produced, high-density plasma 265 is desirably inhibited from entering the process reactor 200 during normal operations of coating and etching of substrates 230 through the use of a feed valve 275 which remains closed 276 until a cleansing cycle 100 has been initiated.

The cleansing cycle 100 is monitored and maintained by the control system 110 which controls the operation of a feed valve 275 and regulates the flow of the high-density plasma 265 through the feed line 270 into the chamber 200. During the cleansing cycle, the high-density plasma 265 is controllably introduced into the chamber 100 to permit the cleansing of the interior walls 220 in a manner that will be described in greater detail hereinbelow.

In one aspect, the high-density plasma 265 comprises plasma having an ion density greater than or equal to 1×10¹² ions/cm³. The high-density plasma 265 is produced using a plasma generator 280 which creates plasma using one or more methods such as, for example; microwave generated plasma, inductively coupled plasma (ICP), electron cyclotron resonance plasma (ECRP), and Helicon wave plasma (HWP). The high-density plasma generator 280 preferably produces plasma using gaseous components suitable for reacting with the polymer material 201 and may include; SF₆, NF₃, and/or O₂. The gaseous composition used to form the high-density plasma in the illustrated embodiment contains between 10% and 100% SF₆, H₂, NH₃, CF₄, NF₃, and/or O₂ with a balance of N₂, Ar, or He.

FIG. 2B further illustrates the apparatus used for in-situ cleansing of the process chamber 200 wherein the cleansing cycle has been initiated by the control system 110. The cleansing cycle 100 commences with a high density plasma feed 281 into the interior 215 of the reactor chamber 200. The plasma flow 281 is regulated by the feed valve 275 which is opened 285 by the control system 100 and used to fill the chamber 200. In one aspect, the chamber 200 is filled to a pressure between approximately 0.01 Torr and 1 Torr, most preferably between 0.05 Torr and 0.5 Torr. Additionally, the ambient temperature of the reactor core 215 should be between 0° C. and 250° C., most preferably between 20° C. and 100° C.

The control system 110 monitors the introduction of the high-density plasma 265 entering chamber 200 and strikes a cleansing plasma 290 within the chamber 200 when the flow of high-density plasma 265 has been enabled into the chamber 290. The cleansing plasma 290 is created by the power supply 240 and electrode apparatus 225a, 225b which induce an RF or capacitive discharge into the high-density plasma 261 which has been pumped into the reactor 200. The resulting energy discharge speeds up the plasma ions and creates a substantial increase in heat and energy within the cleansing plasma 290. The resulting cleansing plasma 290 is highly energized and has increased effectiveness in reacting with the polymer material 201.

The plasma strike additionally increases the plasma potential within the reactor 200 and creates a voltage differential near the interior walls 220. The increased voltage differential beneficially accelerates cleansing plasma ions 295 towards the interior walls 220, bombarding the polymer surface 201 with highly-reactive cleansing plasma particles 290. Ion bombardment of the polymer surface 201 in the aforementioned manner improves the rate of cleaning of the chamber 200 due, in part, to the increased kinetic energy of the cleansing plasma particles 290. The increase in energy contributes to a greater percentage of cleansing plasma particles 290 having the necessary activation energy to react with the polymer. Thus, in the cleansing environment of the process chamber 200, collisions between the cleansing plasma particles 290 and the polymer are more likely to result in the favorable decomposition of the polymer surface 201 into a volatile gas or complex which can be readily removed from the chamber 200.

In-situ cleansing is thus improved by a combination of factors including: the increase in cleansing plasma density within the reactor 200, the increase in energy of the cleansing plasma ions 290 (in the form of heat), and the increased plasma potential present in the reactor core 215. These factors contribute to improved cleansing efficiency and speed with which the polymer material 201 can be removed from the reactor 200.

It will be appreciated by those of skill in the art that other reactor configurations can be modified accommodate the cleansing apparatus and method of the present invention. For example, the cleansing apparatus, including the control system 110 and the separate high-density plasma source 280 can be configured to function with a showerhead reactor, a tube reactor, a high-density plasma reactor, a linear injector atmospheric pressure reactor, or the like. Furthermore, the reactor shape, as shown in FIGS. 2A and 2B, is but one of many possible configurations and may be modified to accommodate other reactor designs or specifications. The cleansing apparatus of the present invention can be implemented in any of the aforementioned reactor designs or configurations and thus should be considered to be additional embodiments of the present invention when used in conjunction with the method of cleansing as described in greater detail hereinbelow.

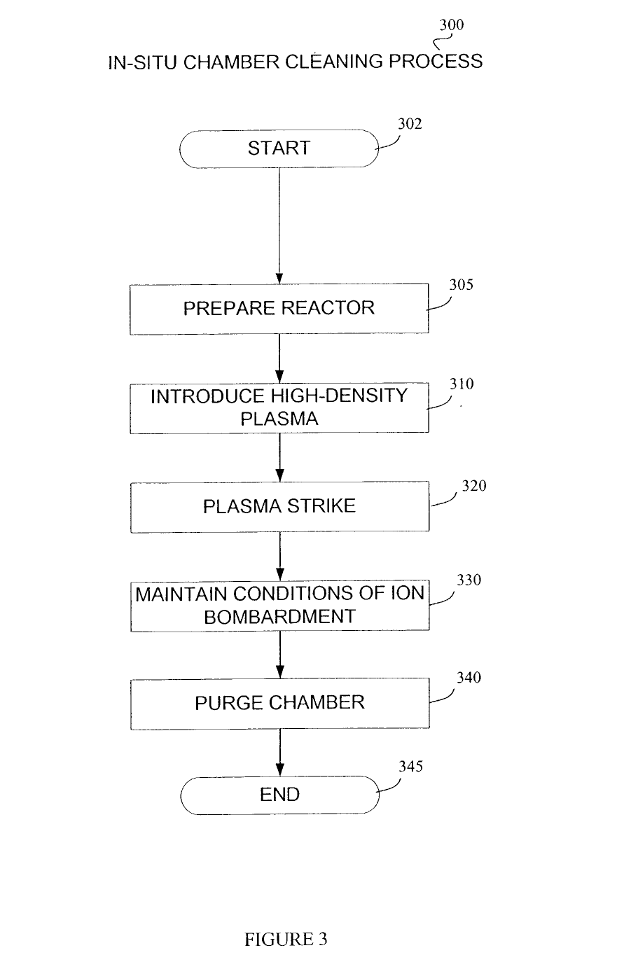

FIG. 3 illustrates a flow diagram for an in-situ chamber cleaning process 300 according to the present invention. Beginning in a start state 302 the process proceeds to a prepare reactor state 305. In this state 305, the reactor 200 may be purged of existing gases 260 and plasma 250 so as to prevent interaction with the high-density plasma 265 or cleansing plasma 290 to be subsequently introduced. Additionally, the substrate material 230 may be removed from the chamber 200 so as to prevent possible damage or contamination by the high-density plasma 265, cleansing plasma 290 or byproducts of the reacted polymer 201.

After the chamber 200 has been sufficiently prepared 305, the process 300 proceeds to introduce high-density plasma 310 into the reactor core 215. As previously discussed, the flow of high-density plasma 265 is regulated and monitored by the control system 110 to achieve the desired concentrations and pressure within the chamber 200. During this step 210 and subsequent steps, the control system 110 may increase or decrease plasma flow 281 into the chamber 200 by regulating the feed valve 275, as necessary, to compensate for transient alterations in the concentration of the plasma within the chamber 200.

Subsequently, the process 300 proceeds to a plasma strike state 320 wherein the plasma density is increased through the RF or capacitive discharge. The plasma strike additionally raises the temperature of the plasma and increases its reactivity to polymer material 201. Furthermore, the plasma strike serves to raise the plasma potential within the chamber 200 and initiate the ion bombardment 295 of the reactor side walls 220. The combined action of these factors creates an environment within the chamber 200 which is amenable to the reaction of the plasma with the polymer material.

The highly-reactive cleansing plasma 290 is subsequently maintained 330 by the control system for a duration of between approximately 10 sec and 1200 sec, preferably between 30 sec and 300 sec. During this time, the control system 110 regulates the flow of high-density plasma 265 entering the chamber 200 and the RF or capacitive discharge across the electrodes 225a, 225b to maintain the conditions of temperature, pressure and duration within the aforementioned parameters.

The process 300 concludes with a purge chamber state 340 wherein the resultant products formed from the reaction of the cleansing plasma 290 with the polymer material 201 are expelled from the interior 215 of the chamber 200. At this time, the chamber 200 is made ready for subsequent coating or etching runs of the chamber 200 by purging the cleansing plasma 290 and returning the chamber 200 to operational parameters of temperature, pressure, and gaseous composition which are suitable for normal substrate processing.

In a typical diode reactor, when the layer of undesirable film or polymer material reaches a thickness of between approximately 0.1 microns and 10 microns, the in-situ chamber cleaning cycle 100 is desirably initiated. It has been observed that the occurrence of adherent polymer material 201 following a single in-situ cleansing cycle 100 can be reduced by between 50% and 100%. Thus, the illustrated embodiments of the present invention provide a safer, more effective cleansing tool than existing methods and reduce the time and effort required to complete the cleaning process.

As discussed above, this process has specific application in the process of manufacturing transistors as the metal layers of the gate stack can be protected during the source/drain reoxidation process. However, it will be appreciated that this process may also be applied in a number of different implementations to desirably protect other selected components from oxidation. These components may include, for example, conductors, electrodes, and the like.

Although the foregoing description of the invention has shown, described and pointed out novel features of the invention, it will be understood that various omissions, substitutions, and changes in the form of the detail of the apparatus as illustrated, as well as the uses thereof, may be made by those skilled in the art without departing from the spirit of the present invention. Consequently the scope of the invention should not be limited to the foregoing discussion but should be defined by the appended claims.

What is claimed is:

1. A method of cleaning solid polymer-based residue off of the interior walls of a process chamber, the method comprising:
introducing an externally produced dissociated gas stream having a plurality of first particles and ions into the chamber which combine with atoms in the polymer residue so as to transform portions of the residue into a gas to thereby remove the polymer residue from the interior walls; and
creating a potential difference between the ions in the gas stream the process chamber to thereby accelerate the ions of the dissociated gas stream into the walls while the first particles are combining with the polymer residue to thereby accelerate the removal of the polymer residue from the walls.

2. The method of claim 1, wherein introducing the dissociated gas stream into the process chamber comprises introducing a plasma stream wherein the plurality of first particles are free radical particles that react with the polymer residue so as to transform the polymer residue from a solid into a gas.

3. The method of claim 2, wherein introducing the disassociated gas stream into the process chamber comprises introducing at least one cleansing gas selected from the group consisting of SF₆, NF₃, CF₄, NH3, H₂ and O₂.

4. The method of claim 3, wherein the disassociated gas stream comprises approximately 10% to 100% cleansing gas with a balance of inert gas.

5. The method of claim 4, wherein the inert gas comprises at least one gas selected from the group consisting of N₂, Ar and He.

6. The method of claim 3, wherein the cleansing gas is at least partially dissociated to form free radicals that combine with carbon atoms in the solid polymer-based residue to form the gas and thereby remove the residue from the walls.

7. The method of claim 1, wherein the solid polymer-based residue comprises at least one compound selected from the group consisting of CF₂, CHF, CH₂, and SiOx.

8. The method of claim 1, wherein the dissociated gas stream introduced into the process chamber has an ion density of at least 1×10² ions/cm³.

9. The method of claim 1, wherein the dissociated gas stream introduced into the process chamber is maintained at a pressure between approximately 0.01 Torr and 1 Torr.

10. The method of claim 1, wherein the dissociated gas stream is introduced into the process chamber maintained at a temperature of between approximately 0° C. and 250° C.

11. A method for cleaning adherent polymer material from interior surfaces of a process chamber, the method comprising;
creating a externally produced, high-density plasma in a plasma generator for introduction into the process chamber
subsequently introducing the high-density plasma into the process chamber;
striking a plasma discharge within the process chamber;
inducing a voltage differential within the chamber so as to bombard the interior surfaces of the process chamber with ions in the plasma; and
maintaining the plasma and the voltage differential for a duration to clean the polymer material from the interior surfaces by reacting the plasma with the polymer material to form a less adherent material.

12. The method of claim 11, wherein introducing the high-density plasma comprises introducing the plasma maintained at a pressure between approximately 0.01 Torr and 1 Torr.

13. The method of claim 11, wherein introducing the high-density plasma comprises introducing the plasma with an ion density between approximately 1×10² ions/cm³ and 1×10¹⁴ ions/cm³.

14. The method of claim 13, wherein introducing the high-density plasma comprises introducing a plasma formed from at least one compound selected from the group consisting of SF₆, NF₃, CF₄, NH₃, H₂ and O₂.

15. The method of claim 11, wherein striking a plasma generating charge comprises striking a charge between approximately 20 volts and 100 volts.

16. The method of claim 11, wherein the plasma is maintained within the process chamber at a temperature of between approximately 0° C. and 250° C.

17. The method of claim 11, wherein inducing the voltage differential comprises creating a capacitive discharge which further ionizes the high-density plasma and increases the temperature of the high-density plasma.

18. The method of claim 17, wherein inducing the voltage differential improves the reactivity of the high-density plasma with the polymer material.

19. The method of claim 17, wherein inducing the voltage differential produces high-density plasma with increased ion density by reducing ion recombination.

20. The method of claim 11, wherein maintaining the plasma and the voltage differential converts at least a portion of the polymer material from a solid phase to a gaseous phase.

21. An in-situ cleansing apparatus, used to remove adherent polymer material, the apparatus comprising:
a process chamber having a shell, enclosing a reactor core, and having internal surfaces which are coated with the polymer material;
an electrode apparatus positioned within the process chamber and coupled to a capacitive power supply to be used for transmitting electromagnetic radiation into the reactor core;
a plasma generator, separate from the process chamber which creates a high-density plasma feed;
a control system coupled to the electrode apparatus and the plasma generator which is used to controllably introduce the high-density plasma feed into the process chamber and simultaneously introduce a potential difference in the process chamber to form a high-density cleansing plasma within the reactor core that accelerates reactive particles in the high-density plasma feed toward the chamber walls to thereby more efficiently remove the adherent polymer material.

22. The cleansing apparatus of claim 21, further comprising a feed line and a feed valve joining the process chamber and the plasma generator to permit the high-density plasma feed to be directed into the reactor core.

23. The cleansing apparatus of claim 22, wherein the control system is coupled to the feed valve so as to control the high-density plasma feed into the reactor core.

24. The cleansing apparatus of claim 23, wherein the control system further induces the electrode apparatus to strike a plasma within the reactor core after the high-density plasma has been fed into the reactor core.

25. The cleansing apparatus of claim 21, wherein the electrode apparatus and capacitive power supply generate a voltage differential between the plasma and the walls of between approximately 20 volts and 100 volts.

26. The cleansing apparatus of claim 21, wherein the plasma generator generates a high-density plasma with an ion density of at least 1×10² ions/cm³.

27. The cleansing apparatus of claim 21, wherein the plasma generator is selected from the group consisting of, microwave plasma generators, inductively coupled plasma generators, electron cyclotron resonance plasma generators, and helicon wave plasma generators.

28. The cleansing apparatus of claim 21, wherein the process chamber comprises a reactor selected from the group consisting of a showerhead reactor, a tube reactor, a high-density plasma reactor, and a linear injector atmospheric pressure reactor.

29. The cleansing apparatus of claim 21, wherein the high-density plasma feed comprises at least one cleansing gas selected from the group consisting of SF₆, NF₃, and O₂.

30. The cleansing apparatus of claim 21, wherein the polymer material comprises at least one compound selected from the group consisting of CF₂, CHF, CH₂ and SiOx.
